(19) United States
(12) Patent Application Publication
(10) Pub. No.: US 2011/0307771 A1
(43) Pub. Date: Dec. 15, 2011

(54) METHOD FOR GENERATING FINANCIAL REPORT

(76) Inventor: Wai Man LOK, Kwai Chung (HK)

(21) Appl. No.: 12/815,437

(22) Filed: Jun. 15, 2010

(51) Int. Cl. G06F 17/00; G06F 17/30; G06F 3/048

(52) U.S. Cl. 715/212; 715/769; 707/769; 707/E17.014

(57) ABSTRACT

The present invention relates to data query technologies, and provides a method for generating a financial report, comprising: generating a query instance module in an operation window when a user dragging and dropping a query instance button in the operation window is detected; generating a query condition input module which is then inserted into the query instance module when the user dragging and dropping a query condition button to said generated query instance module is detected; generating a report template selection module which is then inserted into the query instance module when the user dragging and dropping a report template button to the query instance module is detected; searching data which satisfies a query condition when the user inputting the query condition into the query condition input module is detected; and organizing the searched data to generate a financial report through a selected report template and displaying the generated financial report in a resulting window when the user selecting the report template in the report template selection module is detected. The method of the present invention is easy to operate and use.

### FIELD OF THE INVENTION

The present invention relates generally to data query Technologies, and more specifically, to a method for generating a financial report.

### BACKGROUND OF THE INVENTION

Using database technology to generate a financial report has become a customary technical means in the prior art. Desired data may be found in the database through inputting data query statements and setting the corresponding query conditions, and may be exported in a selected format, then a desired financial report can be obtained.

However, it is difficult for general financial staff to use the data query statements, that is, for many financial staff, learning how to use the data query statements to enquiry data and generate financial reports is a very difficult task.

Therefore, there is a need for a user-friendly method for generating financial reports.

### SUMMARY OF THE INVENTION

The present invention is intended to provide a method for generating a financial report, in order to overcome the disadvantages, such as difficult to use, of the conventional methods for generating financial reports.

According to an aspect of the invention, a method for generating a financial report is provided, comprising the steps of:

generating a query instance module in an operation window when a user dragging and dropping a query instance button in the operation window is detected;

generating at least one corresponding query condition input module which is then inserted into said generated query instance module when the user dragging and dropping at least one of a plurality of query condition buttons in the operation window to said generated query instance module is detected;

generating at least one corresponding report template selection module which is then inserted into said generated query instance module when the user dragging and dropping at least one of a plurality of report template buttons in the operation window to said generated query instance module is detected;

searching data which satisfies at least one query condition and displaying the searched data in a resulting window when the user inputting said at least one query condition into said at least one query condition input module is detected.

Advantageously, the step of displaying the searched data in a resulting window further comprises:

organizing the searched data to generate a financial report through a selected report template and displaying said generated financial report in the resulting window when the user selecting one of a plurality of report templates in said at least one report template selection module is detected.

Advantageously, the step of displaying the searched data in a resulting window further comprises:

organizing the searched data to generate a financial report through a report template associated with said query instance module, and displaying said generated financial report in the resulting window.

Advantageously, the report template is a vertical template or a horizontal template.

Advantageously, said method further comprises generating said query instance module at a position where the query instance button is dragged and dropped to.

Advantageously, each of said at least one corresponding query condition input module comprises at least one condition input field.

Advantageously, at least one of said at least one condition input field is a condition selection box.

Advantageously, said method further comprises:

inserting another query instance module into said generated query instance module when the user dragging and dropping said another query instance module to said generated query instance module is detected, wherein said another query instance module contains at least one query condition.

Advantageously, said method further comprises:

searching data which satisfies both the at least one query condition inputted into said generated query instance module and the at least one query condition inputted into said another query instance module.

Advantageously, the resulting window comprises a spreadsheet.

Advantageously, the spreadsheet comprises an Excel worksheet.

Advantageously, said plurality of report template buttons comprise at least horizontal template buttons and vertical template buttons.

Advantageously, said plurality of query condition buttons comprise at least an “Account” button, a “Value” button, a “Ledger” button, and a “Period” button.

According to an aspect of the invention, a machine-readable storage is provided, having stored thereon a computer program having at least one code section for generating a financial report, the at least one code section being executable by a machine for causing the machine to perform the steps comprising:

generating a query instance module in an operation window when a user dragging and dropping a query instance button in the operation window is detected;

generating at least one corresponding query condition input module which is then inserted into said generated query instance module when the user dragging and dropping at least one of a plurality of query condition buttons in the operation window to said generated query instance module is detected;

generating at least one corresponding report template selection module which is then inserted into said generated query instance module when the user dragging and dropping at least one of a plurality of report template buttons in the operation window to said generated query instance module is detected;

searching data which satisfies at least one query condition and displaying the searched data in a resulting window when the user inputting said at least one query condition into said at least one query condition input module is detected.

Advantageously, said at least one code section further comprises codes for displaying the searched data in a resulting window, comprising:

organizing the searched data to generate a financial report through a selected report template and displaying said generated financial report in the resulting window when the user selecting one of a plurality of report templates in said at least one report template selection module is detected.

Advantageously, said at least one code section further comprises codes for generating said query instance module at a position where the query instance button is dragged and dropped to.

Advantageously, each of said at least one corresponding query condition input module comprises at least one condition input field.

Advantageously, at least one of said at least one condition input field is a condition selection box.

Advantageously, said at least one code section further comprises codes for inserting another query instance module into said generated query instance module when the user dragging and dropping said another query instance module to said generated query instance module is detected, wherein said another query instance module contains at least one query condition.

Advantageously, said at least one code section further comprises codes for searching data which satisfies both the at least one query condition inputted into said generated query instance module and the at least one query condition inputted into said another query instance module.

Advantageously, the resulting window comprises a spreadsheet.

Advantageously, the spreadsheet comprises an Excel worksheet.

The method for generating financial reports in accordance with embodiments of the present invention provides a graphical user interface for inputting query statements and query conditions, thus the operation process is very easy to learn and master. In addition, a plurality of report templates are preset to facilitate users selecting a desired template for generating the financial reports.

### BRIEF DESCRIPTION OF THE DRAWINGS

The accompanying drawings illustrate one or more embodiments of the invention and, together with the written description, serve to explain the principles of the invention, and wherein:

FIG. 1 is a schematic diagram showing an interface for generating a financial report in accordance with an embodiment of the present invention.

FIG. 2 is a flowchart showing a process for generating a financial report in accordance with an embodiment of the present invention.

FIG. 3A is a schematic diagram showing an interface for generating a financial report in accordance with an embodiment of the present invention.

FIG. 3B is a schematic diagram showing an interface for generating a financial report in accordance with an embodiment of the present invention.

FIG. 3C is a schematic diagram showing a query condition input module in accordance with an embodiment of the present invention.

FIG. 3D is a schematic diagram showing an interface of a report template selection module in accordance with an embodiment of the present invention.

FIG. 3E is a schematic diagram showing a plurality of template options in accordance with an embodiment of the present invention.

FIG. 3F is a schematic diagram of a financial report in accordance with an embodiment of the present invention.

FIG. 3G is a schematic diagram showing an interface for generating a financial report in accordance with an embodiment of the present invention.

FIG. 3H is a schematic diagram of a vertical template in accordance with an embodiment of the present invention.

FIG. 3I is a schematic diagram of a hybrid template in accordance with an embodiment of the present invention.

### DETAILED DESCRIPTION OF THE INVENTION

These and other aspects of the present invention will become apparent from the following description of the preferred embodiment taken in conjunction with the following drawings. It should be understood that the embodiments described here are only for the purposes of illustration and description and is not intended to be exhaustive or to limit the invention to the precise forms disclosed.

The present invention relates to a method for generating a financial report, providing a graphic user interface for inputting query statements and query conditions, thus the operation process is very easy to learn and master. In addition, a plurality of report templates are preset to facilitate users selecting a desired template for generating the financial reports. The method for generating a financial report of the present invention will be detailedly described from the following description of the preferred embodiment taken in conjunction with the following drawings.

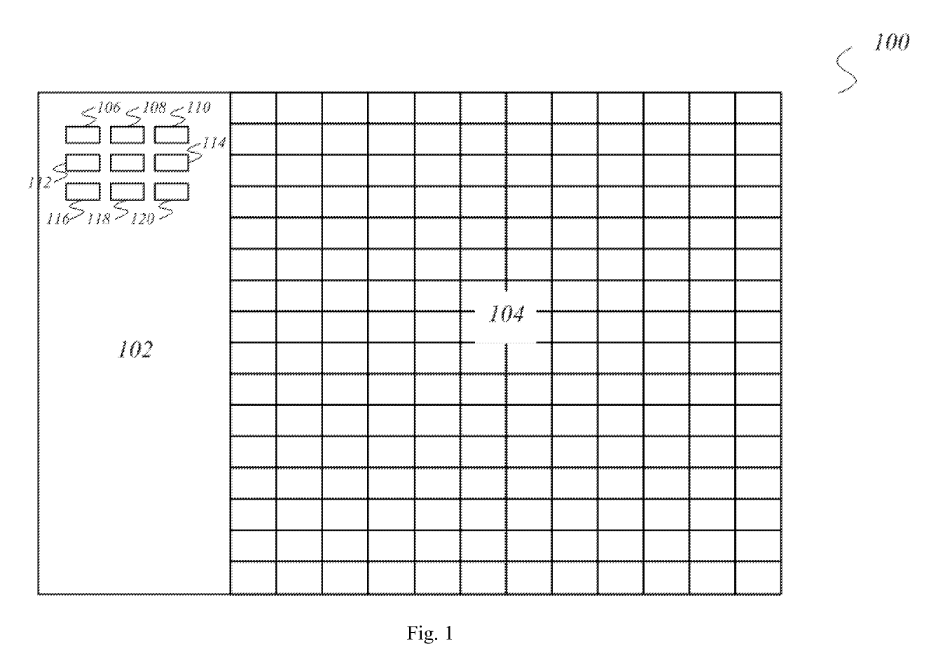

FIG. 1 is a schematic diagram showing an interface 100 for generating a financial report in accordance with an embodiment of the present invention. As shown in FIG. 1, the interface 100 comprises an operation window 102 and a resulting window 104. The operation window 102 further contains a query instance button 106, a plurality of query condition buttons 108˜116, a plurality of report template buttons 118˜120. The method for generating a financial report of the present invention will be detailedly described below in conjunction with the interface 100 as shown in FIG. 1.

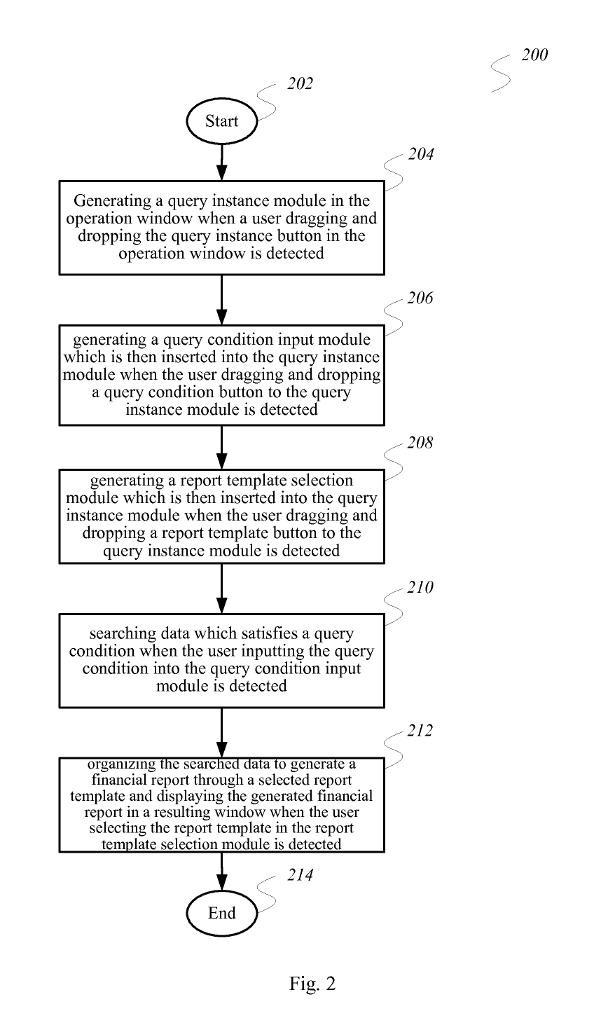

FIG. 2 is a flowchart showing a process 200 for generating a financial report in accordance with an embodiment of the present invention. As shown in FIG. 2, the process 200 begins with step 202.

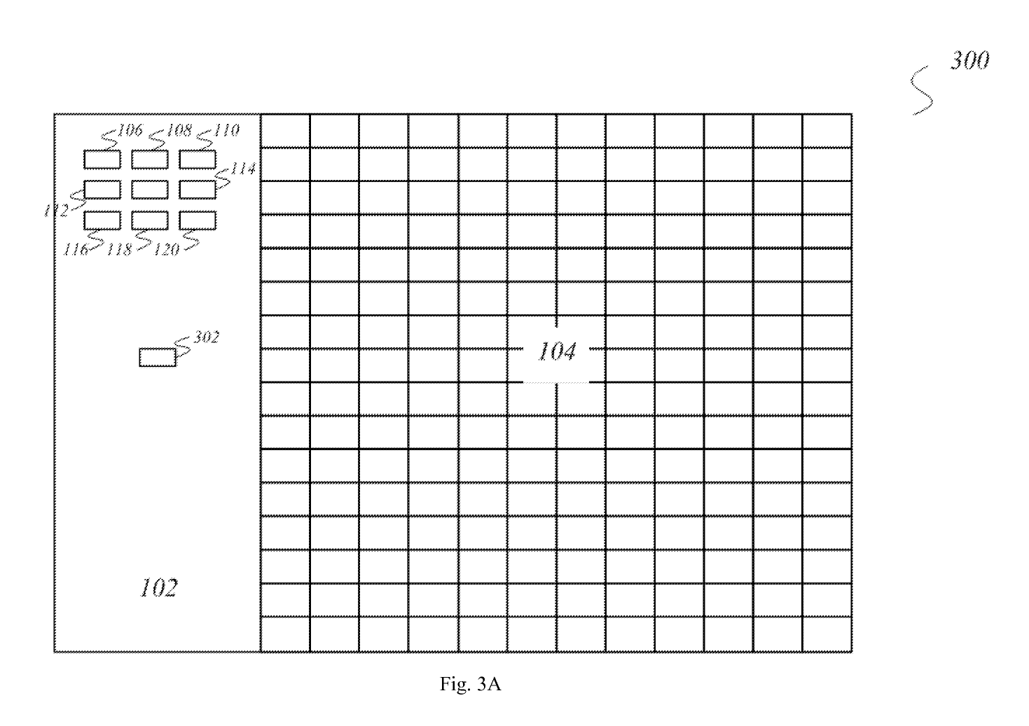

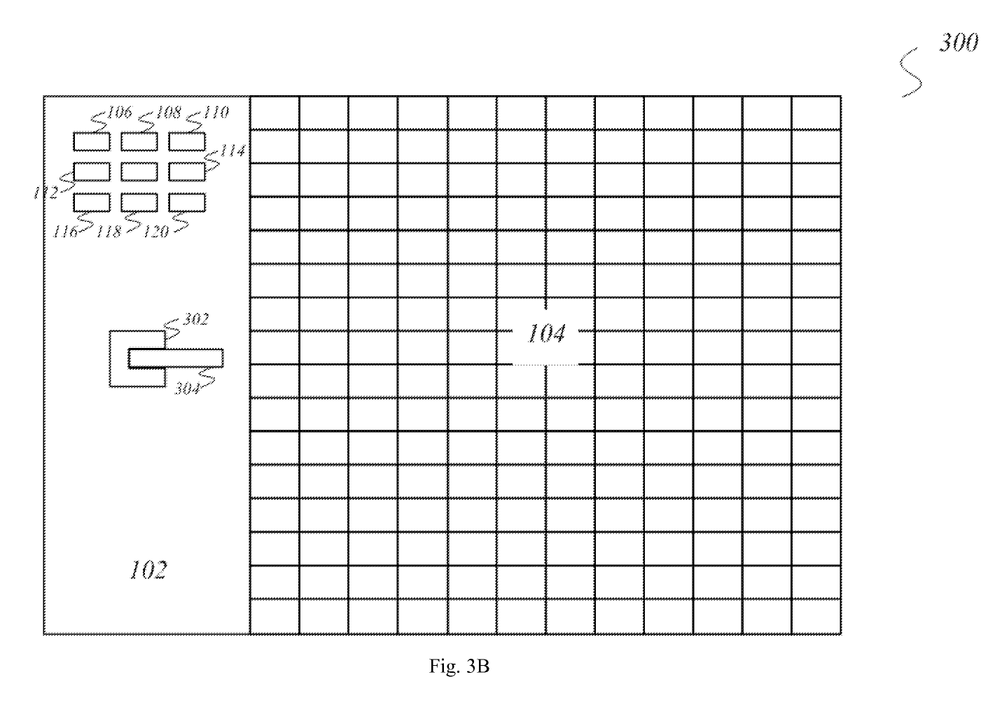

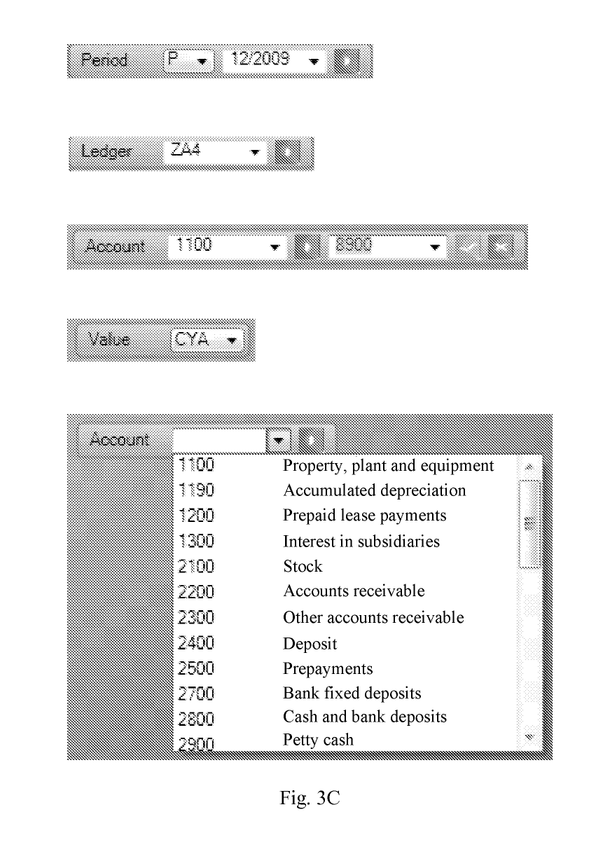

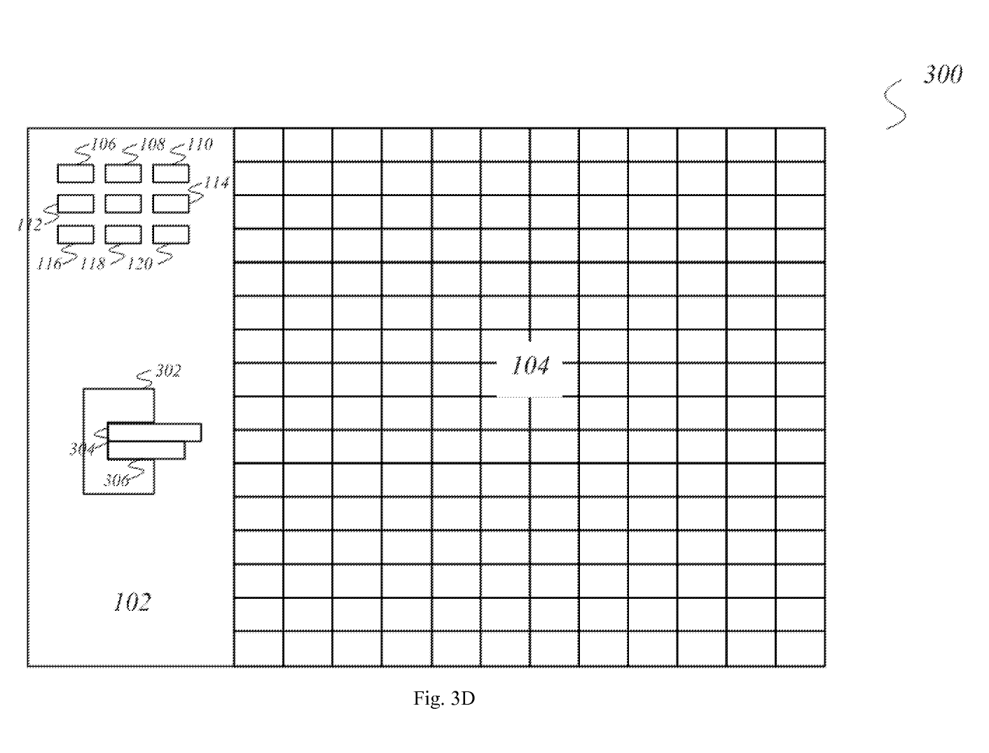

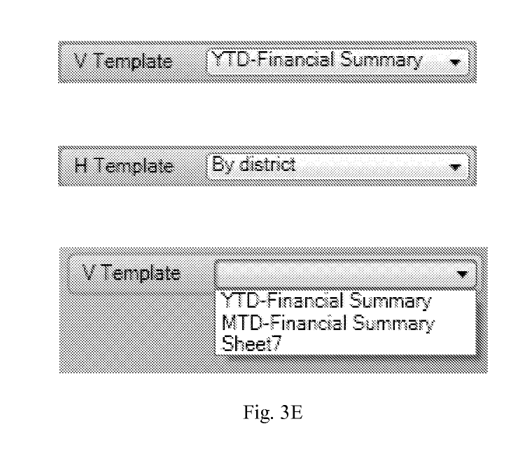

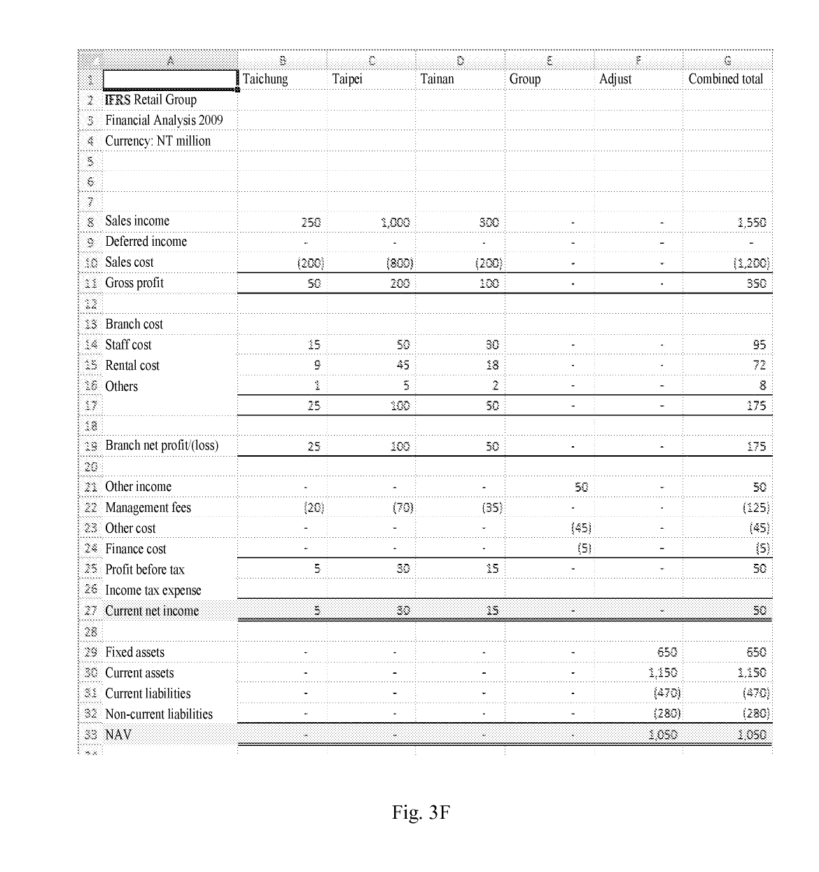

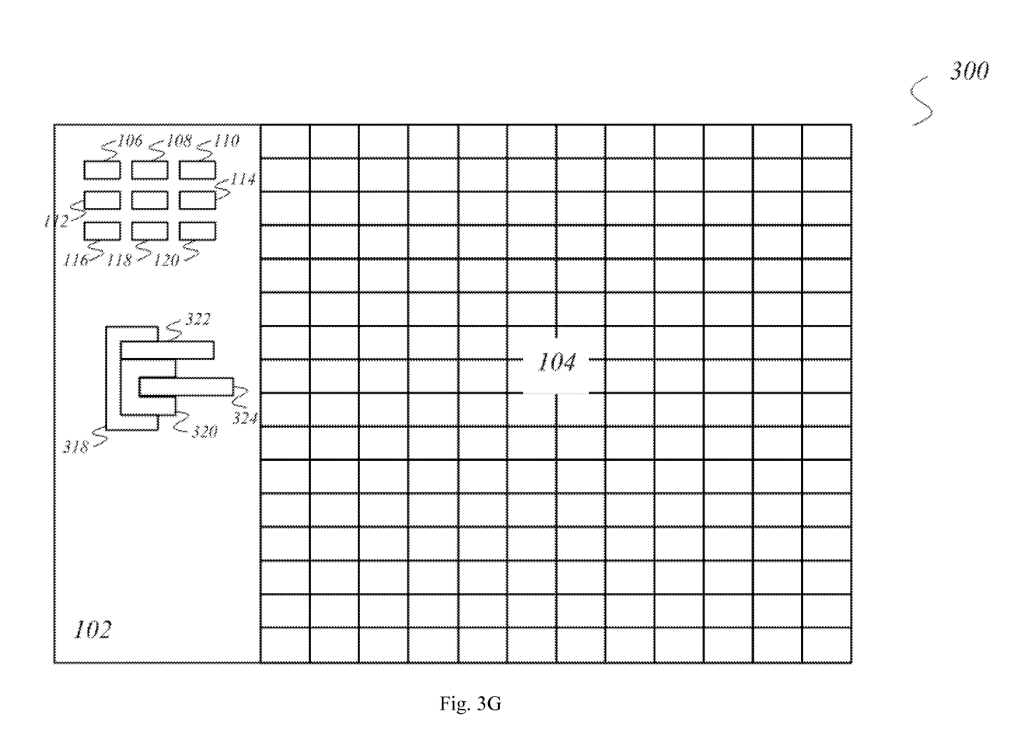

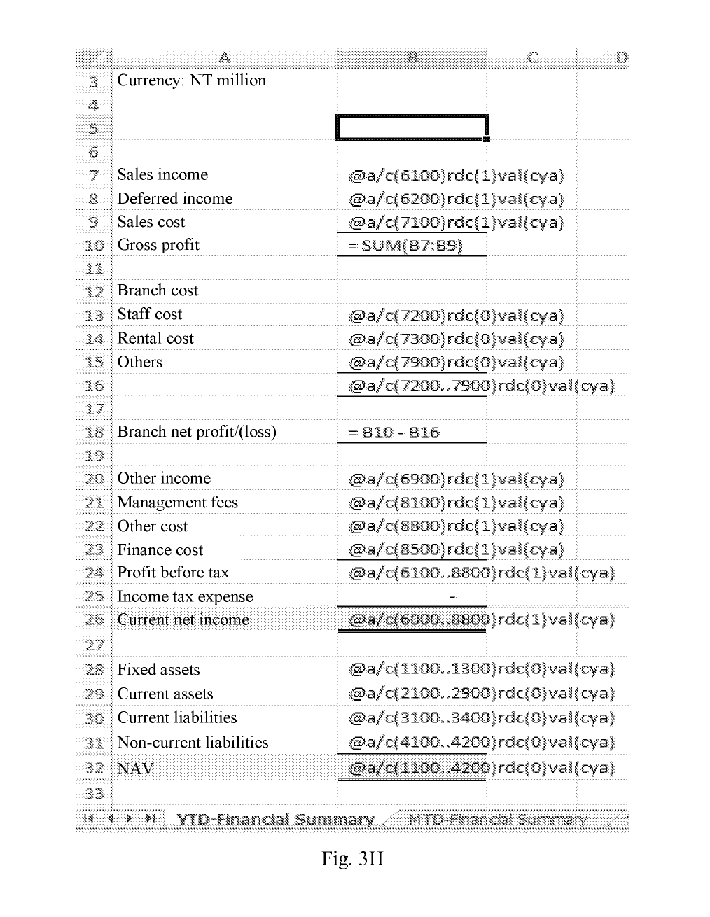

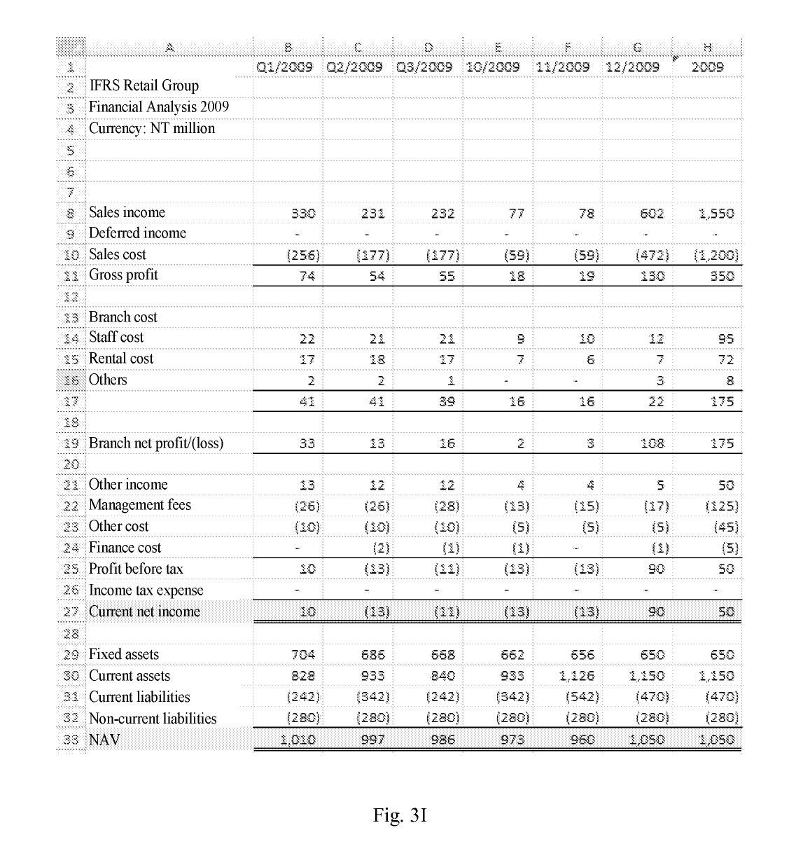

Then in step 204, a query instance module is generated in the operation window when a user dragging and dropping the query instance button in the operation window is detected. In this regard, the interface for generating a financial report is shown in FIG. 3A, wherein the module 302 is just the generated query instance module.

In an embodiment of the present invention, the query instance module may be generated at a position where the query instance button is dragged and dropped to.

Next in step 206, when the user dragging and dropping at least one of a plurality of query condition buttons in the operation window to said generated query instance module is detected, at least one corresponding query condition input module is generated and inserted into said generated query instance module. In this regard, the interface for generating a financial report is shown in FIG. 3B, wherein, the query instance module will be deformed when the users drag and drop at least one of the plurality of query condition buttons in the operation window to said generated query instance module. The query instance module 302 and the generated query condition input module 304 after operation of step 206 are shown in FIG. 3B.

In an embodiment of the present invention, the plurality of query condition buttons comprise at least an “Account” button, a “Value” button, a “Ledger” button, and a “Period” button. Alternatively, the plurality of query condition buttons may further comprise a “Currency” button and a “Analysis” button. The query condition input module generated from dragging and dropping the corresponding query condition button may comprises a plurality of condition input fields. A specific embodiment for the query condition input module generated from dragging and dropping the query condition button is shown in FIG. 3C. Referring to FIG. 3C, at least one of the condition input fields may be a condition selection box.

Next in step 208, when the user dragging and dropping at least one of a plurality of report template buttons in the operation window to said generated query instance module is detected, at least one corresponding report template selection module is generated and inserted into said generated query instance module. The query instance module 302, the generated query condition input module 304, and the generated report template selection module after operation of step 208 are shown in FIG. 3D.

In an embodiment of the present invention, the plurality of report template buttons may comprise at least horizontal template buttons and vertical template buttons. Further, the report template selection module associated with each of the horizontal template buttons may provide a plurality of template options. In an embodiment of the present invention, the vertical template button, the horizontal template button, and the plurality of template options in the associated report template selection module are shown in FIG. 3E.

It should be noted that in various embodiments of the present invention, the report template buttons are not necessary. For example, the query process can be reduced so as to omit the report template buttons. In addition, the query instance module generated from dragging and dropping the query instance button may be associated with a default report template. For example, a query instance module which has a default report template (for example but not limited to a horizontal template or a vertical template) is generated when drag and drop the query instance button.

Next in step 210, when the user inputting at least one query condition into said at least one query condition input module is detected, data which satisfies said at least one query condition is searched. As shown in FIG. 3C, the user may input a condition in each condition input field to initiate a search operation for searching data which satisfies the inputted query conditions. In an embodiment of the present invention, when the user inputs at least one query condition, a query formula corresponding to the query condition is generated. The formula is used to compute data which satisfies the query condition.

Next in step 212, when the user selecting one of a plurality of report templates in said at least one report template selection module is detected, the searched data is organized to generate a financial report through the selected report template, and then the generated financial report is displayed in the resulting window.

In an embodiment of the present invention, the at least one report template selection module comprises at least a horizontal template selection module and a vertical template selection module, wherein each horizontal template associated with the horizontal template selection module defines various components in the horizontal direction (each component is associated with a class of data that the user needs to enquiry); each vertical template associated with the vertical template selection module defines various components in the vertical direction.

It should be noted that in an embodiment of the present invention, the user may select both a horizontal template and a vertical template, i.e., a hybrid template, in order to display the data needed more accurately. In this regard, a plurality of components are provided in both of the horizontal direction and the vertical direction. Data displayed in a cell of the spreadsheet where a row that a horizontal component lies in and a column that a vertical component lies in are crossed with each other, satisfies both the horizontal component and the vertical component.

Additionally, it should be noted that step 212 (i.e., the step of selecting a report template and organizing the searched data to generate a financial report through the selected report template) is not a necessary step. Further in step 210, after the data which satisfies the query condition is computed, it may be displayed directly in the resulting window. However, in cases that the amount of the computed data is huge or the result is complicated, the report templates can be used to organize the searched data so as to display the data clearly.

FIG. 3H is a schematic diagram of a vertical template in accordance with an embodiment of the present invention. As shown in FIG. 3H, a plurality of data components are arranged in the vertical direction, such as sales income, deferred income, sales cost, gross profit, and so on. Content associated with each data component is the data searched and computed according to the query conditions inputted by the user. In order to show the particular search and computation process, as shown in FIG. 3H, the specific computation formulas are displayed in the spreadsheet which displays the data associated with each component.

FIG. 3I is a schematic diagram of a hybrid template in accordance with an embodiment of the present invention. As shown in FIG. 3I, a plurality of data components are arranged in the horizontal direction, such as sales income, deferred income, sales cost, gross profit, and so on. In addition, also a plurality of data components are arranged in the vertical direction, such as Q1/2009, Q2/2009, Q3/2009, and so on. In this regard, data displayed in a cell of the spreadsheet where a row that a horizontal component lies in and a column that a vertical component lies in are crossed with each other, satisfies both the horizontal component and the vertical component.

Therefore, the user can obtain various formats of data through selecting different templates (for example, a vertical template, a horizontal template and a hybrid template).

In various embodiments of the present invention, the resulting window may be a spreadsheet, more particularly, a Excel worksheet.

In an embodiment of the present invention, the generated financial report displayed in the resulting window is shown in FIG. 3F.

It should be noted that in an embodiment of the present invention, when the user dragging and dropping another query instance module in the operation window to the generated query instance module is detected, the process 200 further comprises inserting said another query instance module into the generated query instance module, wherein said another query instance module contains at least one query condition. In this case, the interface for generating a financial report is shown in FIG. 3G. Referring to FIG. 3G, two query instance modules 318 and 320 are illustrated, and the query instance module 320 is inserted into the query instance module 318. Further, the query instance module 318 contains a query condition 322, while the query instance module 320 contains a query condition 324. In this case, data that satisfies both the query condition 322 of the query instance module 318 and the query condition 324 of the query instance module 320 needs to be searched. Finally, a financial report is generated from the searched data.

The present invention further provides a machine-readable storage, having stored thereon a computer program having at least one code section for generating a financial report, the at least one code section being executable by a machine for causing the machine to perform the steps comprising:

generating a query instance module in an operation window when a user dragging and dropping a query instance button in the operation window is detected;

generating at least one corresponding query condition input module which is then inserted into said generated query instance module when the user dragging and dropping at least one of a plurality of query condition buttons in the operation window to said generated query instance module is detected;

generating at least one corresponding report template selection module which is then inserted into said generated query instance module when the user dragging and dropping at least one of a plurality of report template buttons in the operation window to said generated query instance module is detected;

searching data which satisfies at least one query condition and displaying the searched data in a resulting window when the user inputting said at least one query condition into said at least one query condition input module is detected.

In an embodiment of the present invention, said at least one code section further comprises codes for displaying the searched data in a resulting window, comprising:

organizing the searched data to generate a financial report through a selected report template and displaying said generated financial report in the resulting window when the user selecting one of a plurality of report templates in said at least one report template selection module is detected.

In an embodiment of the present invention, said at least one code section further comprises codes for displaying the searched data in a resulting window, comprising:

organizing the searched data to generate a financial report through a report template associated with said query instance module, and displaying said generated financial report in the resulting window.

In an embodiment of the present invention, the report template is a vertical template or a horizontal template.

In an embodiment of the present invention, said at least one code section further comprises codes for generating said query instance module at a position where the query instance button is dragged and dropped to.

In an embodiment of the present invention, each of said at least one corresponding query condition input module comprises at least one condition input field. Further, at least one of said at least one condition input field is a condition selection box.

In an embodiment of the present invention, said at least one code section further comprises codes for inserting another query instance module into said generated query instance module when the user dragging and dropping said another query instance module to said generated query instance module is detected, wherein said another query instance module contains at least one query condition.

In an embodiment of the present invention, said at least one code section further comprises codes for searching data which satisfies both the at least one query condition inputted into said generated query instance module and the at least one query condition inputted into said another query instance module.

In an embodiment of the present invention, the resulting window comprises a spreadsheet. For example, the spreadsheet comprises an Excel worksheet.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for generating a financial report, comprising the steps of:
generating a query instance module in an operation window when a user dragging and dropping a query instance button in the operation window is detected;
generating at least one corresponding query condition input module which is then inserted into said generated query instance module when the user dragging and dropping at least one of a plurality of query condition buttons in the operation window to said generated query instance module is detected;
generating at least one corresponding report template selection module which is then inserted into said generated query instance module when the user dragging and dropping at least one of a plurality of report template buttons in the operation window to said generated query instance module is detected;
searching data which satisfies at least one query condition and displaying the searched data in a resulting window when the user inputting said at least one query condition into said at least one query condition input module is detected.

2. The method according to claim 1, wherein the step of displaying the searched data in a resulting window further comprises:
organizing the searched data to generate a financial report through a selected report template and displaying said generated financial report in the resulting window when the user selecting one of a plurality of report templates in said at least one report template selection module is detected.

3. The method according to claim 1, wherein the step of displaying the searched data in a resulting window further comprises:
organizing the searched data to generate a financial report through a report template associated with said query instance module, and displaying said generated financial report in the resulting window.

4. The method according to claim 3, wherein the report template is a vertical template or a horizontal template.

5. The method according to claim 1, wherein said method further comprises generating said query instance module at a position where the query instance button is dragged and dropped to.

6. The method according to claim 1, wherein each of said at least one corresponding query condition input module comprises at least one condition input field.

7. The method according to claim 6, wherein at least one of said at least one condition input field is a condition selection box.

8. The method according to claim 1, wherein said method further comprises:
inserting another query instance module into said generated query instance module when the user dragging and dropping said another query instance module to said generated query instance module is detected, wherein said another query instance module contains at least one query condition.

9. The method according to claim 8, wherein said method further comprises:
searching data which satisfies both the at least one query condition inputted into said generated query instance module and the at least one query condition inputted into said another query instance module.

10. The method according to claim 1, wherein the resulting window comprises a spreadsheet.

11. The method according to claim 10, wherein the spreadsheet comprises an Excel worksheet.

12. The method according to claim 2, wherein said plurality of report template buttons comprise at least horizontal template buttons and vertical template buttons.

13. The method according to claim 1, wherein said plurality of query condition buttons comprise at least an “Account” button, a “Value” button, a “Ledger” button, and a “Period” button.

14. A machine-readable storage, having stored thereon a computer program having at least one code section for generating a financial report, the at least one code section being executable by a machine for causing the machine to perform the steps comprising:
generating a query instance module in an operation window when a user dragging and dropping a query instance button in the operation window is detected;
generating at least one corresponding query condition input module which is then inserted into said generated query instance module when the user dragging and dropping at least one of a plurality of query condition buttons in the operation window to said generated query instance module is detected;
generating at least one corresponding report template selection module which is then inserted into said generated query instance module when the user dragging and dropping at least one of a plurality of report template buttons in the operation window to said generated query instance module is detected;
searching data which satisfies at least one query condition and displaying the searched data in a resulting window when the user inputting said at least one query condition into said at least one query condition input module is detected.

15. The machine-readable storage according to claim 14, wherein said at least one code section further comprises codes for displaying the searched data in a resulting window, comprising:
organizing the searched data to generate a financial report through a selected report template and displaying said generated financial report in the resulting window when the user selecting one of a plurality of report templates in said at least one report template selection module is detected.

16. The machine-readable storage according to claim 14, wherein said at least one code section further comprises codes for generating said query instance module at a position where the query instance button is dragged and dropped to.

17. The machine-readable storage according to claim 14, wherein each of said at least one corresponding query condition input module comprises at least one condition input field.

18. The machine-readable storage according to claim 17, wherein at least one of said at least one condition input field is a condition selection box.

19. The machine-readable storage according to claim 14, wherein said at least one code section further comprises codes for inserting another query instance module into said generated query instance module when the user dragging and dropping said another query instance module to said generated query instance module is detected, wherein said another query instance module contains at least one query condition.

20. The machine-readable storage according to claim 19, wherein said at least one code section further comprises codes for searching data which satisfies both the at least one query condition inputted into said generated query instance module and the at least one query condition inputted into said another query instance module.
